(19) United States
(12) Patent Application Publication
(10) Pub. No.: US 2011/0059724 A1
(43) Pub. Date: Mar. 10, 2011

(54) hand-portable electronic device for verifying an input test sequence of characters against a predetermined sequence of characters

(76) Inventors: Flemming Abilidgaard, Roskilde (DK); Gerald J. Stanton, Shelton, CT (US)

(21) Appl. No.: 10/579,883

(22) PCT Filed: Nov. 18, 2003
(86) PCT No.: PCT/IB03/06285

§ 371 Date: Nov. 13, 2007

(51) Int. Cl. H04M 1/66

(52) U.S. Cl. 455/411

(57) ABSTRACT

A hand-portable electronic device including a memory for storing a security word as a predetermined sequence of characters; a rotator, having a tactile surface arranged for tactile actuation by a user, and mounted for rotation about an axis; feedback means separate from the rotator for providing feedback to a user as the rotator is rotated; conversion means for converting each rotation of a sequence of rotations of the rotator into a character of a corresponding ordered test sequence of characters; and verification means for verifying the test sequence of characters against the predetermined sequence of characters. A security method for a hand-portable electronic device including a rotator, the method including a user making an ordered sequence of rotations of the rotator; providing at the device, separately from the rotator, feedback to the user as the rotator is rotated during the ordered sequence of rotations; and verifying whether the ordered sequence of rotations made by the user corresponds to a predetermined ordered sequence of rotations.

### TECHNICAL FIELD

Embodiments of the invention relate to a hand-portable electronic device for verifying an input test sequence of characters against a predetermined sequence of characters and a security method for a hand-portable electronic device.

### BACKGROUND OF THE INVENTION

Currently hand-portable electronic devices use security methods to restrict access to the device or one or more of its functions. For example, some current mobile cellular telephones may be configured so that a user must enter a security PIN code when the device is switched on in order to use the device.

Typically such a device has a memory that stores a security word as a predetermined sequence of characters, typically numbers. When the telephone is switched on, the user inputs a sequence of digits using the numeric keypad of the mobile telephone. As each digit is entered a ‘*’ is displayed on a display. When the user has finished entering the sequence she selects a function key and the mobile telephone verifies the user input sequence of characters against the stored predetermined sequence of characters. If verification is successful access to the device is allowed. If verification is unsuccessful access to the device is denied.

### BRIEF SUMMARY OF THE INVENTION

According to one embodiment of the present invention there is provided a hand-portable electronic device comprising: a memory for storing a security word as a predetermined sequence of characters; a rotator, having a tactile surface arranged for tactile actuation by a user, and mounted for rotation about an axis; feedback means separate from the rotator for providing feedback to a user as the rotator is rotated; conversion means for converting each rotation of a sequence of rotations of the rotator into a character of a corresponding ordered test sequence of characters; and verification means for verifying the test sequence of characters against the predetermined sequence of characters.

According to one embodiment of the present invention there is provided a security method for a hand-portable electronic device comprising a rotator, the method comprising: a user making an ordered sequence of rotations of the rotator; providing at the device, separately from the rotator, feedback to the user as the rotator is rotated during the ordered sequence of rotations; and verifying whether the ordered sequence of rotations made by the user corresponds to a predetermined ordered sequence of rotations.

### BRIEF DESCRIPTION OF THE DRAWINGS

For a better understanding of the present invention reference will now be made by way of example only to the accompanying drawings in which:

FIG. 1 illustrates a hand-portable electronic device 10;

FIGS. 2A and 2B schematically illustrate one example of a rotator input device 30 in cross-section and plan views; and

FIGS. 3A, 3B, 3C and 3D illustrate visual feedback provided to the user by the display 16.

### DETAILED DESCRIPTION OF EMBODIMENT(S) OF THE INVENTION

In embodiments of the invention, a user can perform a security method at an electronic device 10 by making an ordered sequence of rotations of the rotator 32. The device 10 provides separately from the rotator 32, feedback to the user as the rotator 32 is rotated during the ordered sequence of rotations. There is verification whether the ordered sequence of rotations made by the user corresponds to a predetermined ordered sequence of rotations. This verification may occur at the device 10.

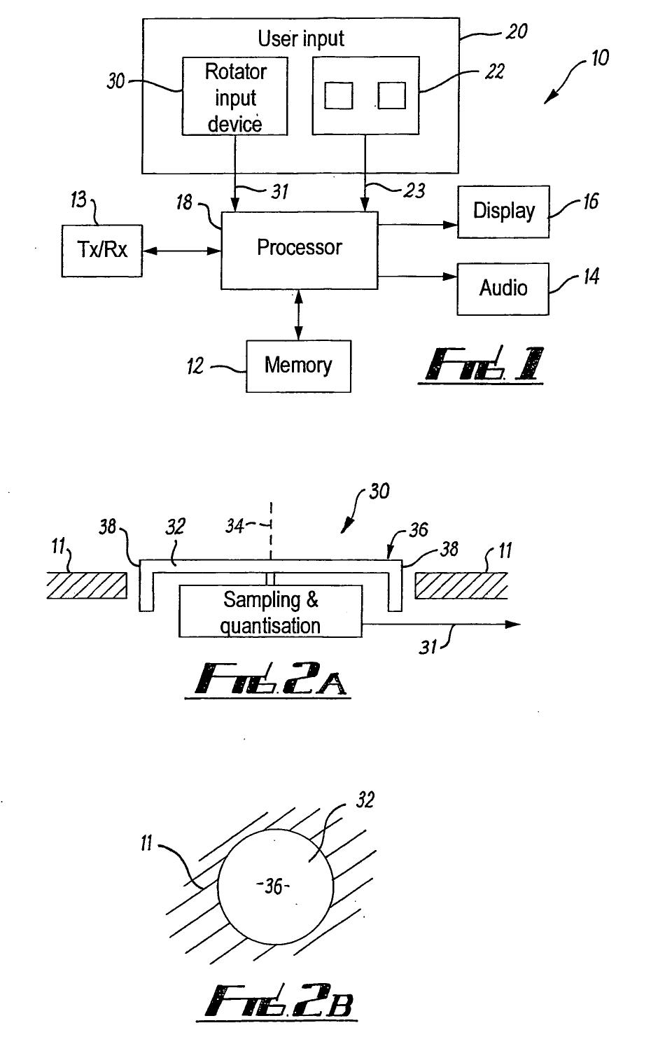

FIG. 1 illustrates a hand-portable electronic device 10 comprising: a memory 12, a user input 20, an audio output device 14, a display output device 16 and a processor 18. The processor 18 is connected to receive control inputs from the user input 20 and to provide respective control signals to the audio output device 14 and the display 16. The processor 18 is also connected to read from and write to the memory 12.

The audio output device 14 provides an electrically amplified audio output to the user.

The memory 12 stores a security word as a predetermined sequence of characters. The predetermined sequence of characters may be specified by the user.

The hand-portable electronic device, in this example, is operable as a mobile cellular telephone. In other examples, the hand-portable electronic device does not have this functionality. The electronic device 10 additionally comprises a cellular radio transceiver 13 connected to the processor 18 that enables communication in a cellular radio telecommunications network (not shown).

The user input 20 comprises a rotator input device 30 and additional function keys 22. The rotator input device 30 provides a first control input 31 to the processor 18 and the function keys 22 provide second control inputs 23 to the processor 18.

The rotation input device 30 comprises a user-rotatable rotator. Rotation of the rotator varies, in a continuous analogue manner, an electrical characteristic of the rotator input device. The electrical characteristic is regularly sampled and quantised to give a quantised value. The quantized value is one of a discrete set of quantised values each of which represents a different rotational position of the rotator. The quantised value is regularly provided to the processor 18 as the time-varying digital first control signal 31.

One example of a rotator input device 30 is schematically illustrated in cross-section in FIG. 2A and in plan view in FIG. 2B.

The rotator input device 30, in this example, replaces a keypad. The rotator input device 30 may be used for data entry such as dialling a telephone number or alphanumeric text entry. Each one of a plurality of different rotational positions of the rotator may correspond to a different input character.

The rotator input device 30 comprises a disk-like rotator 32 mounted for rotation about an axis 34 in response to tactile actuation by a user. The disk-like rotator 32 has a circular, flat upper tactile surface 36 that is presented for tactile actuation by a user.

In use, the user touches the upper tactile surface 36 with a digit. As the digit is moved, while contacting the upper tactile surface 36, friction between the user's digit and the upper tactile surface 36 causes the disk-like rotator to rotate.

The circular upper tactile surface 36 has a downwardly depending curved edge 38 that is substantially inaccessible to a user. The axis of rotation 34 is, in this example, substantially perpendicular to the upper tactile surface 36. The electronic device 10 has a front face 11 and the axis of rotation 34 is, in this example, substantially perpendicular to the front face 11 of the electronic device.

The processor 18 provides means for verifying a contemporaneous user-entered sequence of rotations of the rotator (a test sequence) against a predetermined sequence of rotations of the rotator. If the verification is successful, the security procedure has been successfully completed and access is allowed. If the verification is unsuccessful, the security procedure has been unsuccessfully completed and access is denied. Access may be to the general use of the electronic device 10 itself or some function provided by the device.

The processor 18 receives the first control signal 31 from the rotator input device 30. This signal indicates the current rotational position of the rotator 32. The processor 18 also receives a second control signal 23 from a first function key when it is selected by the user to indicate the termination of a rotation and from a second function key when it is selected to indicate termination of a sequence of rotations.

A user rotates the rotator and then presses the first function key to indicate the termination of a rotation. This is repeated for each rotation in the sequence of rotations of the rotator. The user then presses the second function key to indicate the termination of the sequence of rotations.

On each termination of a rotation, the processor 18 converts the current quantised value provided by the first control signal 23 to one data value in a set of data values—a “character”. In this example, the conversion is to an ASCII character value. The processor 18 stores the character in the memory 12 as a sequential addition to a test sequence of characters.

On termination of the sequence of rotations as indicated by input from the second function key, the processor 18 verifies the user-entered test sequence of characters against the stored predetermined sequence of characters. If the verification is successful, the security procedure has been successfully completed and access is allowed. If the verification is unsuccessful, the security procedure has been unsuccessfully completed and access is denied. Access may be to use the electronic device 10 itself or some function provided by the device.

The processor 18, in addition to performing the security access function described above, also controls the feedback provided to the user during the security procedure. The feedback provided is separate from any noise or tactile feedback provided via the rotator 32 to a user as the rotator 32 is rotated.

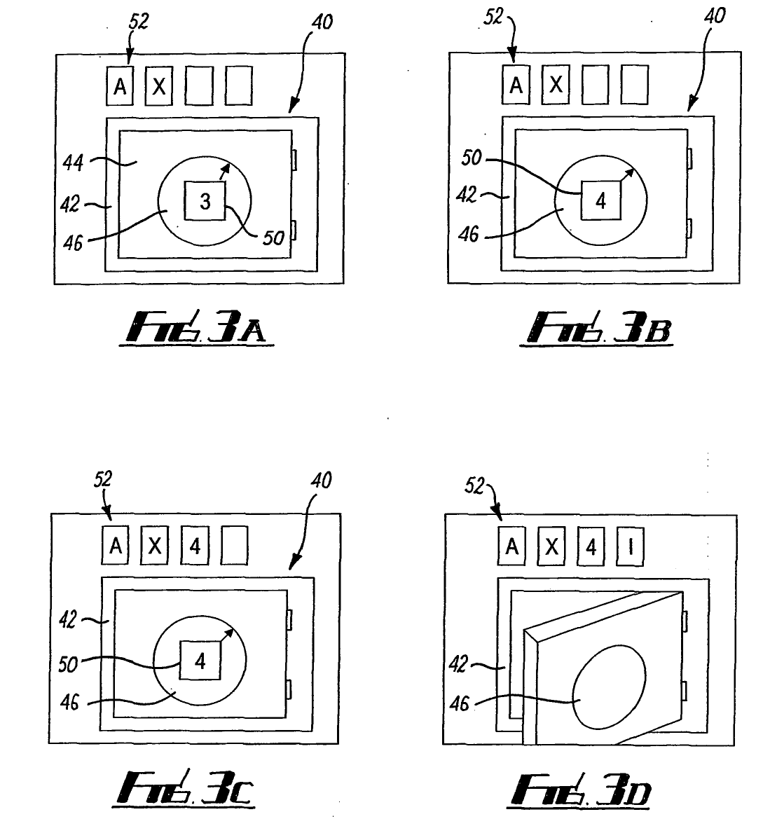

The processor 18 controls the display to provide visual feedback as illustrated in FIGS. 3A, 3B, 3C and 3D.

The display is initially controlled by the processor 18 to display an image of a locked safe 40 as illustrated in FIG. 3A. The image of the safe includes a safe body 42, a safe door 44 and a safe-dial 46 in the safe door 44. A current input character 50 is displayed representing the current rotational position of the safe-dial. A sequence of characters 52 is displayed representing the previously entered rotations of the safe-dial 46 in the current sequence.

The displayed image, when the rotator 32 is rotated clockwise to its next discrete quantised value, is illustrated in FIG. 3B. When the processor 18 determines that the first input signal 31 has changed because the rotator has been rotated to its next discrete quantised value the processor 18 converts the new current quantised value to a character and displays that character, rotates the safe-dial in the displayed image of the safe and provides a first audio control signal to the audio output device.

In more detail, when the processor 18 determines that the first input signal 31 has changed the processor 18 converts the current quantised value provided by the first control signal 23 to an ASCII character value and displays that value as the current input character. In this example, the displayed current input character 50 is “4”. The value of the displayed current input character increases discretely as the rotator is rotated in a clockwise direction and the value decreases discretely as the rotator is rotated in an anti-clockwise direction. The display, under the control of the processor 18, provides feedback on the absolute extent of rotation of the rotator as represented by the current input character 50.

In more detail, when the processor 18 determines that the first input signal 31 has changed, the processor 18 converts the change in the first input signal 31 into a change in the displayed image of a safe, so that the safe-dial in the displayed image appears to rotate with and in the same sense as the rotator. The rotational position is illustrated in the Figs using an arrow.

In more detail, when the processor 18 determines that the first input signal 31 has changed the processor 18 provides a first audio control signal to the audio output device. This signal controls the audio output device to produce a ‘click’ sound that emulates the sound made when a safe-dial is rotated. Thus the audio output device, under the control of the processor 18, provides feedback on the relative changes in rotational position of the rotator. Each predetermined gradation in the rotation of the rotator provides a change in the quantised signal that in turn provides a ‘click’.

When the processor 18 determines that a rotation has been terminated, it controls the image in the display such that the current input character is transferred into the sequence of characters as the latest character in the sequence of characters 52 as illustrated in FIG. 3C.

If the verification of the security procedure is successful the processor 18 controls the image presented in the display 16 so that it appears as if the safe door is opening as illustrated in FIG. 3D and simultaneously controls the audio output device to make a sound similar to a safe door opening.

In the above description, the end of a rotation is indicated by a user pushing the first function key. In other implementations, the termination of a rotation may be indicated by a user in a different manner. For example, the user may reverse the direction of rotation of the rotator and the processor 18 may be arranged to detect a reversal and take the quantised value before the reversal as the input value at the termination of the rotation. For example, the user may pause the movement of the rotator e.g. for greater than 0.5 seconds and the processor 18 may be arranged to detect such a pause and take the quantised value at the pause as the input value at the termination of the rotation.

Although embodiments of the present invention have been described in the preceding paragraphs with reference to various examples, it should be appreciated that modifications to the examples given can be made without departing from the spirit and scope of the invention as claimed. For example although a disk-like rotator is described other shapes of rotators may be used. For example, the rotator may have a wheel-like shape or a barrel-like shape where the user actuates the curved surface of the rotator. For example, although in the described example the verification procedure occurs at the device, it may alternatively occur else where. For example, a remote station may store the security word as a predetermined sequence of characters, the device may send a message to the remote station indicative of the test sequence of characters and the remote station may provide verification means for verifying the received test sequence of characters against the stored predetermined sequence of characters.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A hand-portable electronic device comprising:
a memory for storing a security word as a predetermined sequence of characters;
a rotator, having a tactile surface arranged for tactile actuation by a user, and mounted for rotation about an axis;
feedback means separate from the rotator for providing feedback to a user as the rotator is rotated;
conversion means for converting each rotation of a sequence of rotations of the rotator into a character of a corresponding ordered test sequence of characters; and
verification means for verifying the test sequence of characters against the predetermined sequence of characters.

2. A hand-portable electronic device as claimed in claim 1, wherein the conversion means is arranged to quantise the extent of rotation of the rotator to one of a discrete set of quantised values.

3. A hand-portable electronic device as claimed in claim 2, wherein the feedback means is responsive to each variation of a quantised value during a rotation to provide feedback to the user indicative of the quantised value.

4. A hand-portable electronic device as claimed in claim 2, wherein the quantised value at the termination of a rotation corresponds to a character of the test sequence.

5. A hand-portable electronic device as claimed in claim 1, wherein the feedback means is an output device.

6. A hand-portable electronic device as claimed in claim 5, wherein the feedback means is an audio output device

7. A hand-portable electronic device as claimed in claim 6, wherein the audio output device provides a first audible output for each predetermined gradation of rotation of the rotator

8. A hand-portable electronic device as claimed in claim 7, wherein the first audible output emulates the ‘click’ heard on rotating a safe dial.

9. A hand-portable electronic device as claimed in claim 6, wherein the audio output device provides a second audible output on correct verification of the test sequence of characters against the predetermined sequence of characters.

10. A hand-portable electronic device as claimed in claim 9, wherein the second audible output emulates the sound of safe door opening.

11. A hand-portable electronic device as claimed in claim 5, wherein the feedback means comprises a display.

12. A hand-portable electronic device as claimed in claim 11, wherein the feedback means varies a displayed character as the rotator is rotated.

13. A hand-portable electronic device as claimed in claim 12, wherein the value of the displayed character increases as the rotator is rotated in a first direction of rotation and value of the displayed character decreases as the rotator is rotated in a second opposite direction of rotation.

14. A hand-portable electronic device as claimed in claim 11, wherein the display is arranged to display each of the characters in the ordered test sequence of characters.

15. A hand-portable electronic device as claimed in claim 1, wherein the feedback means comprises a display for displaying a representation of at least a safe dial.

16. A hand-portable electronic device as claimed in claim 15, wherein the displayed safe dial rotates as the rotator is rotated.

17. A hand-portable electronic device as claimed in claim 16, wherein the display is arranged to display a safe door opening on the correct verification of the test sequence of characters against the predetermined sequence of characters.

18. A hand-portable electronic device as claimed in claim 1, wherein the rotator has an upper tactile surface corresponding to the rotator tactile surface and wherein the rotator is mounted for rotation about an axis substantially perpendicular to said upper tactile surface in response to tactile actuation by a user.

19. A hand-portable electronic device as claimed in claim 1, wherein the electronic device has a front face and the rotator has an upper tactile surface corresponding to the rotator tactile surface and wherein the rotator is mounted for rotation about an axis substantially perpendicular to the front face of the electronic device in response to tactile actuation by a user.

20. A hand-portable electronic device as claimed in claim 1, wherein the rotator is disk-like having a substantially circular, flat, non-curved upper tactile surface.

21. A hand-portable electronic device as claimed in claim 20, wherein a downwardly depending curved edge to the substantially circular upper tactile surface of the disc-like rotator is substantially inaccessible.

22. A hand-portable electronic device as claimed in claim 1, wherein the rotator is for data entry.

23. A security method for a hand-portable electronic device comprising a rotator, the method comprising:
a user making an ordered sequence of rotations of the rotator;
providing at the device, separately from the rotator, feedback to the user as the rotator is rotated during the ordered sequence of rotations; and
verifying whether the ordered sequence of rotations made by the user corresponds to a predetermined ordered sequence of rotations.

24. A security method as claimed in claim 23, wherein when the device provides feedback to the user it provides electrically amplified audio output to the user.

25. A security method as claimed in claim 23, further comprising quantising the rotational position of the rotator to one of a discrete set of quantised values.

26. A security method as claimed in claim 23, further comprising providing at the device, separately from the rotator, feedback to the user indicative of a variation in the quantised value.

27. A security method as claimed in claim 23, further comprising providing at the device, separately from the rotator, feedback to the user indicative of the quantised value.

28. A security method as claimed in claim 23, the device provides, separately from the rotator, feedback to the user as the rotator is rotated through each one of a discrete set of predetermined rotation values.

29. A hand-portable electronic device comprising:
a rotator, having a tactile surface arranged for tactile actuation by a user, and mounted for rotation about an axis;
feedback means separate from the rotator for providing feedback to a user as the rotator is rotated; and
conversion means for converting each rotation of a sequence of rotations of the rotator into a character of a corresponding ordered test sequence of characters,
wherein the ordered test sequence of characters is for verification against a predetermined sequence of characters.

30. (canceled)

31. A hand-portable electronic device as claimed in claim 2, wherein the feedbck means is responsive to each variation of a quantised value during a rotation to provide feedback to the user indicative of a variation in the quantised value.
